(19) United States
(12) Patent Application Publication
(10) Pub. No.: US 2026/0024199 A1
(43) Pub. Date: Jan. 22, 2026

(54) IMAGE PROCESSING APPARATUS, ESTIMATING APPARATUS, IMAGE PROCESSING METHOD, ESTIMATING METHOD, AND NON-TRANSITORY COMPUTER READABLE MEDIUM

(71) Applicant: CANON KABUSHIKI KAISHA, Tokyo (JP)

(72) Inventor: TAKAHIRO KUROYAMA, Kanagawa (JP)

(21) Appl. No.: 19/245,690

(22) Filed: Jun. 23, 2025

(30) Foreign Application Priority Data
Jul. 16, 2024 (JP) 2024-113658

(51) Int. Cl. G06T 7/00

(52) U.S. Cl. CPC G06T 7/0012; G06T 2207/10136; G06T 2207/20081; G06T 2207/30048

(57) ABSTRACT

An image processing apparatus includes an image acquisition unit that acquires a standard cross-section image from a three-dimensional image including an object, a teacher data acquisition unit that acquires teacher data including the standard cross-section image and ground truth data that is information regarding the object, a first learning unit that constructs a first learning model, a pseudo standard cross-section image acquisition unit that acquires a cross-section that differs from the standard cross-section as a pseudo standard cross-section image, based on a relation between an imaging plane of a three-dimensional imaging probe and the standard cross-section, a pseudo ground truth data acquisition unit that acquires pseudo ground truth data using the first learning model, and a second learning unit that constructs a second learning model by performing training of pseudo teacher data including the pseudo standard cross-section image and the pseudo ground truth data.

### BACKGROUND

### Field of the Technology

The present disclosure relates to an image processing apparatus, an estimating apparatus, an image processing method, an estimating method, and a non-transitory computer readable medium.

### Description of the Related Art

In diagnosis using three-dimensional medical images, physicians calculate various types of diagnostic indices by identifying positions of predetermined anatomical landmarks (feature points) or by extracting predetermined anatomical structures (regions), in cross-sectional (standard cross-section) images that physicians use for observation. In recent years, advance in machine learning technology such as deep learning and so forth has enabled identification of anatomical landmarks and extraction of anatomical structures with high precision, in cases in which great amounts of learning data that has sufficient variation is available.

However, unlike general images regarding which great amounts of learning data can be collected relatively easily, there is a problem with medical images in that easily collecting great amounts of learning data that has variation and that contains an object is difficult. Accordingly, technology is being proposed in which learning data for medical images is augmented (data enhancement), thereby effectively performing learning from small amounts of learning data.

For example, in Japanese Patent Laid-Open No. 2023-135836, standard cross-section parameters indicating a position of a standard cross-section in a three-dimensional image are made to vary, cross-section images are generated using the parameters after varying, ground truth data in the cross-section images is calculated, and the ground truth data is added to the learning data, thereby augmenting the learning data.

Also, in Qizhe Xie, et al. “Self-training with Noisy Student improves ImageNet classification”, CVPR, 2020, an estimator (learning model) that is trained with data of which ground truth is known is used to perform estimation with respect to data of which the ground truth is unknown, thereby creating pseudo ground truth data and augmenting the learning data.

However, the above methods according to the conventional technology do not take into consideration positional relation between an image acquisition probe and a subject in ultrasound images, and there was a possibility that images that could not be acquired in actual ultrasound image acquisition would be generated. Also, effectively generating variations with respect to variances that can be acquired in actual ultrasound image acquisition has been difficult.

### SUMMARY

Technology according to the present disclosure has been made in light of the foregoing circumstances, and improves estimation precision of information relating to an object from an image that is imaged of a subject.

According to some embodiments, an image processing apparatus includes an image acquisition unit that acquires a standard cross-section image, which is an image of a standard cross-section, from a three-dimensional image including an object, a teacher data acquisition unit that acquires teacher data including the standard cross-section image and ground truth data that is information regarding the object in the standard cross-section image, a first learning unit that constructs a first learning model by performing training of the teacher data, a pseudo standard cross-section image acquisition unit that acquires, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image, a pseudo ground truth data acquisition unit that acquires pseudo ground truth data that is information of the object in the pseudo standard cross-section image, using the first learning model, and a second learning unit that constructs a second learning model by performing training of pseudo teacher data including the pseudo standard cross-section image and the pseudo ground truth data.

According to some embodiments, an estimating apparatus that estimates information of an object from a cross-section image in a three-dimensional image by using a learning device, wherein the learning device includes a trained model acquisition unit that constructs a first trained model by performing training of a first learning model that estimates information of the object from the cross-section image in the three-dimensional image, using teacher data including a standard cross-section image acquired from the three-dimensional image including the object and ground truth data that is information of the object, acquires, from the three-dimensional image, a pseudo standard cross-section image corresponding to a pseudo standard cross-section that intersects an imaging plane of a three-dimensional imaging probe and that is different from a standard cross-section, acquires information of the object that is estimated using the pseudo standard cross-section image and the first trained model, as pseudo ground truth data, and constructs a second trained model by learning a second learning model using pseudo teacher data including the pseudo standard cross-section image and the pseudo ground truth data, the estimating apparatus includes an input image acquisition unit that acquires a standard cross-section in the three-dimensional image, in which the object is imaged using the three-dimensional imaging probe, as an input image, and an estimating unit that performs estimation of information of the object by the input image and the second trained model.

According to some embodiments, an image processing apparatus includes an image acquisition unit that acquires a standard cross-section image, which is an image of a standard cross-section, from a three-dimensional image including an object, a teacher data acquisition unit that acquires, with respect to the standard cross-section image, teacher data including the standard cross-section image and ground truth data that is information of the object in the standard cross-section image, a pseudo standard cross-section image acquisition unit that acquires, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image, a pseudo teacher data acquisition unit that acquires pseudo teacher data including the pseudo standard cross-section image and the ground truth data corresponding to the standard cross-section image that is used by the pseudo standard cross-section image acquisition unit to acquire the pseudo standard cross-section image, and a learning unit that constructs a learning model that estimates information of the object from a cross-section image in the three-dimensional image, by performing training of the pseudo teacher data.

According to some embodiments, an image processing method includes an image acquisition step of acquiring a standard cross-section image, which is an image of a standard cross-section, from a three-dimensional image including an object, a teacher data acquisition step of acquiring teacher data including the standard cross-section image and ground truth data that is information regarding the object in the standard cross-section image, a first learning step of constructing a first learning model by performing training of the teacher data, a pseudo standard cross-section image acquisition step of acquiring, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image, a pseudo ground truth data acquisition step of acquiring pseudo ground truth data that is information of the object in the pseudo standard cross-section image, using the first learning model, and a second learning step of constructing a second learning model by performing training of pseudo teacher data including the pseudo standard cross-section image and the pseudo ground truth data.

According to some embodiments, an estimating method of estimating information of an object from a cross-section image in a three-dimensional image by using a learning device, wherein the learning device includes a trained model acquisition unit that constructs a first trained model by performing training of a first learning model that estimates information of the object from the cross-section image in the three-dimensional image, using teacher data including a standard cross-section image acquired from the three-dimensional image including the object and ground truth data that is information of the object, acquires, from the three-dimensional image, a pseudo standard cross-section image corresponding to a pseudo standard cross-section that intersects an imaging plane of a three-dimensional imaging probe and that is different from a standard cross-section, acquires information of the object that is estimated using the pseudo standard cross-section image and the first trained model, as pseudo ground truth data, and constructs a second trained model by learning a second learning model using pseudo teacher data including the pseudo standard cross-section image and the pseudo ground truth data, the estimating method includes an input image acquisition step of acquiring a standard cross-section in the three-dimensional image, in which the object is imaged using the three-dimensional imaging probe, as an input image, and an estimating step of performing estimation of information of the object by the input image and the second trained model.

According to some embodiments, an image processing method includes an image acquisition step of acquiring a standard cross-section image, which is an image of a standard cross-section, from a three-dimensional image including an object, a teacher data acquisition step of acquiring, with respect to the standard cross-section image, teacher data including the standard cross-section image and ground truth data that is information of the object in the standard cross-section image, a pseudo standard cross-section image acquisition step of acquiring, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image, a pseudo teacher data acquisition step of acquiring pseudo teacher data including the pseudo standard cross-section image and the ground truth data corresponding to the standard cross-section image that is used by the pseudo standard cross-section image acquisition unit to acquire the pseudo standard cross-section image, and a learning step of constructing a learning model that estimates information of the object from a cross-section image in the three-dimensional image, by performing training of the pseudo teacher data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of an image processing apparatus according to a first embodiment.

FIG. 2 is a flowchart of processing that the image processing apparatus according to the first embodiment executes.

FIG. 3 is a diagram illustrating a schematic configuration of an image processing apparatus according to a second embodiment.

FIG. 4 is a flowchart of processing that the image processing apparatus according to the second embodiment executes.

FIGS. 5A to 5D are diagrams schematically illustrating standard cross-sections in three-dimensional ultrasound images according to an embodiment.

### DESCRIPTION OF THE EMBODIMENTS

Embodiments of an image processing apparatus according to the present disclosure will be exemplarily described in detail below with reference to the attached drawings. However, it should be noted that the components described in the following embodiments are only exemplary, and that the technical scope of the present disclosure is set forth in the aspects, and is not limited to the following individual embodiments.

Technology of the present disclosure will be described by way of an example in which the present disclosure is carried out using a convolutional neural network (CNN), which is one kind of machine learning and is one of estimators based on deep learning.

### First Embodiment

An image processing apparatus according to a first embodiment is an apparatus that performs training of a learning model that estimates a contour point cloud of an object, from standard cross-section images in three-dimensional images that are imaged of an object using a three-dimensional imaging probe. Here, a standard cross-section is a two-dimensional cross-section that is suitable for observing an object in a three-dimensional image. In the present embodiment, a case will be assumed in which three-dimensional ultrasound images of the heart are imaged in an examination of the heart by an ultrasound diagnosis apparatus (ultrasound cardiogram examination) using an ultrasound probe, and the three-dimensional ultrasound images are input to a learning model and the right ventricle is taken as an object. Description will be made below regarding a method in which a standard cross-section image of the right ventricle of the heart that is clipped out of the three-dimensional ultrasound image is taken as input to the learning model, and training of the learning model is performed to estimate two-dimensional coordinate values of a contour point cloud making up the contour of the right ventricle on the standard cross-section.

In the present embodiment, the images that are input to the learning model are three-dimensional images, but images and ground truth data used for training of a teacher model and a student model, which will be described later are two-dimensional standard cross-section images clipped out from the three-dimensional images. That is to say, the teacher model and the student model that are generated by the method according to the present embodiment are learning models that take a two-dimensional standard cross-section image as input, and output information relating to an object in the two-dimensional standard cross-section image. Also, the teacher model is a first learning model that estimates information of the object from the cross-section image in the three-dimensional image, and training by the teacher model yields a first trained model. Also, the student model is a second learning model that estimates information of the object from the cross-section image in the three-dimensional image, and training by the student model yields a second trained model.

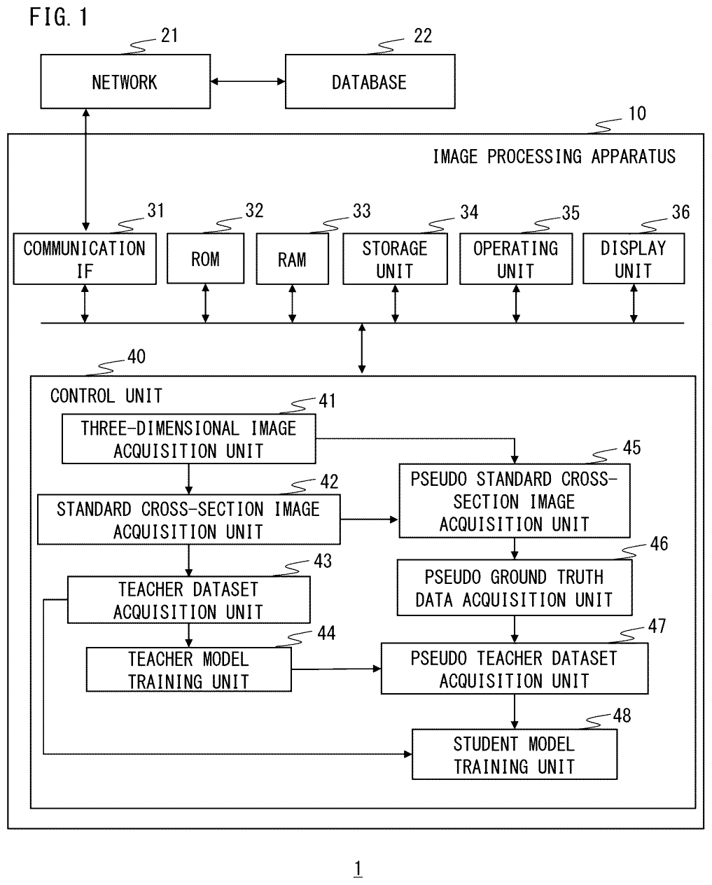

A configuration and processing of the image processing apparatus according to the present embodiment will be described below with reference to FIG. 1. FIG. 1 is a block diagram illustrating an example of a schematic configuration of an image processing system (also referred to as “medical image processing system”) including the image processing apparatus according to the present embodiment. As illustrated in FIG. 1, the image processing system 1 includes the image processing apparatus 10 and a database 22.

The image processing apparatus 10 is connected to the database 22 via a network 21 in a communicable state. Examples of the network 21 include a local area network (LAN) and a wide area network (WAN).

The database 22 holds and manages images and information that are used for processing by the image processing apparatus 10 according to the present embodiment. Information managed in the database 22 includes three-dimensional images acquired by the image processing apparatus 10, standard cross-section parameters used by a standard cross-section image acquisition unit 42 that will be described later, and ground truth data used by a teacher dataset acquisition unit 43. Note that information of three-dimensional images, standard cross-section parameters, and ground truth data may be stored in internal storage of the image processing apparatus 10 (read-only memory (ROM) 32 or storage unit 34), instead of in the database 22. The image processing apparatus 10 acquires data held in the database 22 via the network 21.

The image processing apparatus 10 includes a communication interface (IF) (communication unit) 31, the ROM 32, random access memory (RAM) 33, the storage unit 34, an operating unit 35, a display unit 36, and a control unit 40.

The communication IF (communication unit) 31 is made up of a LAN card or the like, and realizes communication between an external device such as the database 22 and so forth, and the image processing apparatus 10. The ROM 32 is made up of nonvolatile memory and so forth, and stores various types of programs and various types of data. The RAM 33 is made up of volatile memory and so forth, and is used as work memory that temporarily stores programs and data that are currently being executed. The storage unit 34 is made up of a hard disk drive (HDD) or the like, and stores various types of programs and various types of data. The operating unit 35 is made up of a keyboard, a mouse, a touch panel, and so forth, and serves as an input unit that accepts instructions from a user such as a physician, a medical technologist, or the like. The display unit 36 is made up of a display or the like, and displays, to the user, various types of information generated by processing by the image processing apparatus 10 according to the present embodiment.

The control unit 40 is made up of a central processing unit (CPU), or a dedicated or general-purpose processor. The control unit 40 may be made up of a graphic processing unit (GPU) or the like. Alternatively, the control unit 40 may be made up of a field-programmable gate array (FPGA), an application specific integrated circuit (ASIC), or the like. The control unit 40 includes a three-dimensional image acquisition unit 41, the standard cross-section image acquisition unit 42, the teacher dataset acquisition unit 43, a teacher model training unit 44, a pseudo standard cross-section image acquisition unit 45, a pseudo ground truth data acquisition unit 46, a pseudo teacher dataset acquisition unit 47, and a student model training unit 48, which will be described later.

The three-dimensional image acquisition unit 41 acquires a plurality of three-dimensional images that are subject to processing performed in the present embodiment, which are input to the image processing apparatus 10, from the database 22 or the storage unit 34. Note that three-dimensional images may be directly acquired from a modality such as an ultrasound diagnosis apparatus or the like, and in this case the image processing apparatus 10 may be implemented in the modality as a part of functions of the modality.

The standard cross-section image acquisition unit 42 acquires standard cross-section parameters from the database 22 for each of the three-dimensional images acquired by the three-dimensional image acquisition unit 41. The standard cross-section image acquisition unit 42 then uses the standard cross-section parameters that are acquired to clip out and acquire two-dimensional standard cross-section images from the three-dimensional images corresponding to the standard cross-section parameters. Now, the standard cross-section is a two-dimensional cross-section that is suitable for observing the object, and the standard cross-section parameters are parameters representing the position and the orientation of the standard cross-section image in the three-dimensional image. The standard cross-section parameters indicating the position of a standard cross-section image are, for example, a total of six parameters, of three parameters of three-dimensional coordinate values representing a center position of the standard cross-section image, and three parameters of a normal vector representing the orientation of the standard cross-section image. Now, the standard cross-section parameters may be obtained by accepting instructions of parameters from the user at the operating unit 35, or may be based on optional estimation results using the three-dimensional images. Note that the standard cross-section parameters representing the position and the orientation of the standard cross-section in the three-dimensional images are not limited to the above configuration and may be in other expression forms (e.g., expression forms that are expressed by center position and quaternion, Euler angles, or rotation matrix expressing rotation).

The teacher dataset acquisition unit 43 is a teacher data acquisition unit that acquires ground truth data, which is information of the object in the standard cross-section image acquired by the standard cross-section image acquisition unit 42, from the database 22. The teacher dataset acquisition unit 43 acquires a teacher dataset made up of a plurality of pieces of teacher data, with a set (pair) of standard cross-section image and ground truth data as one piece of teacher data. Note that the ground truth data may be information of the object that the user has manually set with respect to the standard cross-section image that is acquired, or may be that which is estimated by the image processing apparatus 10. In the present embodiment, description will be made regarding a case of acquiring two-dimensional coordinate values of a contour point cloud making up the contour of the right ventricle that is rendered in the standard cross-section image of the right ventricle that is clipped out from the three-dimensional ultrasound image of the heart, as a specific example of ground truth data.

The teacher model training unit 44 learns (constructs) a learning model (estimator) that estimates information of the object from the standard cross-section image, using the teacher dataset acquired by the teacher dataset acquisition unit 43.

The pseudo standard cross-section image acquisition unit 45 is a pseudo standard cross-section image acquisition unit that clips out and acquires pseudo standard cross-section images, using the three-dimensional images acquired by the three-dimensional image acquisition unit 41 and the standard cross-section parameters acquired by the standard cross-section image acquisition unit 42. Specifically, the pseudo standard cross-section image acquisition unit 45 varies the position and the orientation of a standard cross-section in the three-dimensional image represented by the standard cross-section parameters, with an imaging plane of the three-dimensional imaging probe in the three-dimensional image as a reference, for each of the three-dimensional images. The pseudo standard cross-section image acquisition unit 45 then clips out images of pseudo standard cross-sections that are different cross-sections from the standard cross-section, from the three-dimensional images, using the positions and orientations of the standard cross-section following varying (pseudo standard cross-sections), and acquires the cross-section images that are clipped out as pseudo standard cross-section images. Thus, the pseudo standard cross-section image acquisition unit 45 acquires images of cross-sections that differ in position or orientation from the standard cross-section as pseudo standard cross-section images. Alternatively, the pseudo standard cross-section image acquisition unit 45 changes normal vectors in the standard cross-section parameters, thereby acquiring images of cross-sections of which the normal directions differ from the standard cross-section, as pseudo standard cross-section images.

The pseudo ground truth data acquisition unit 46 estimates information of the object, in each of the pseudo standard cross-section images acquired by the pseudo standard cross-section image acquisition unit 45, using the learning model that performed training at the teacher model training unit 44 (also referred to as “teacher model”). The pseudo ground truth data acquisition unit 46 then acquires the information of the object that is estimated as pseudo ground truth data.

The pseudo teacher dataset acquisition unit 47 is a pseudo teacher data acquisition unit that acquires a pseudo teacher dataset made up of a plurality of pieces of pseudo teacher data. Pseudo teacher data here is a set of a pseudo standard cross-section image acquired by the pseudo standard cross-section image acquisition unit 45 and pseudo ground truth data acquired by the pseudo ground truth data acquisition unit 46.

The student model training unit 48 performs training of a learning model that estimates information of the object from a standard cross-section image (also referred to as “student model”), using the teacher dataset acquired by the teacher dataset acquisition unit 43 and the pseudo teacher dataset acquired by the pseudo teacher dataset acquisition unit 47. Note that the student model training unit 48 may perform training of the student model using just the pseudo teacher dataset, without using the teacher dataset. The student model training unit 48 is a trained model acquisition unit that acquires the second trained model that estimates information of the object from a cross-section image in a three-dimensional image. Thus, the image processing apparatus according to the present embodiment can also function as an estimating apparatus that estimates information of an object from a cross-section image in a three-dimensional image by using a learning device including a trained model acquisition unit that constructs the first trained model and the second trained model.

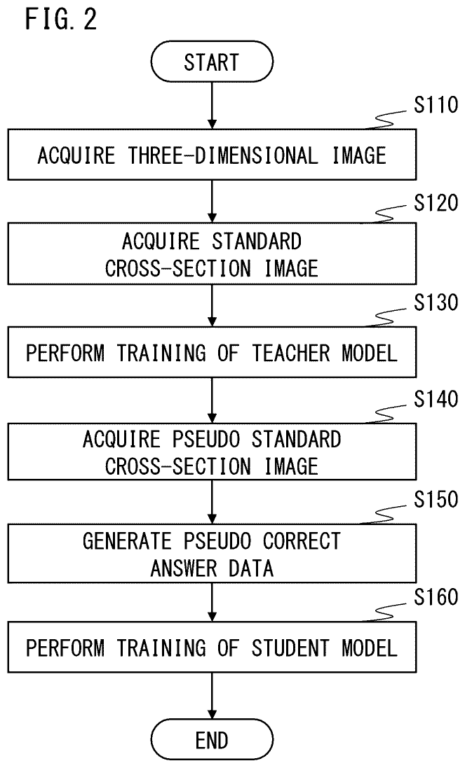

An example of processing by the image processing apparatus 10 in FIG. 1 will be described in detail with reference to a flowchart in FIG. 2.

(Step S110: Acquisition of Three-Dimensional Images) In step S110, the three-dimensional image acquisition unit 41 acquires, from the database 22, a plurality of three-dimensional images containing the object (the right ventricle of the subject here), specified by the user using the operating unit 35, and performs storage thereof in the storage unit 34. The three-dimensional images acquired in step S110 in the present embodiment are three-dimensional ultrasound images of the heart that are imaged using the three-dimensional imaging probe in an ultrasound cardiogram examination. The control unit 40 may at this time display the three-dimensional ultrasound images of the heart that are acquired on the display unit 36.

(Step S120: Acquisition of Standard cross-section Images) In step S120, the standard cross-section image acquisition unit 42 acquires, for each of the three-dimensional images acquired in step S110, standard cross-section parameters corresponding to the three-dimensional images, from the database 22. The standard cross-section image acquisition unit 42 then uses the standard cross-section parameters that are acquired to clip out and acquire a two-dimensional cross-section image from each of the three-dimensional images.

In the present embodiment, the standard cross-section image acquisition unit 42 acquires standard cross-section parameters for a standard cross-section for observing the right ventricle, for each of the three-dimensional ultrasound images of the heart. The standard cross-section image acquisition unit 42 then clips out and acquires an image of a standard cross-section of the right ventricle from each of the three-dimensional ultrasound images, using the standard cross-section parameters that are acquired. In the present embodiment, the standard cross-section is a cross-section by which the left ventricle, the left atrium, the right ventricle, and the right atrium, of the heart, can be observed at the same time (four chamber view). Also, in the present embodiment, a cross-section in which the cardiac apex portion is rendered directly below a distal end of the probe, and also the size of the right ventricle is greatest, is defined as the standard cross-section of the right ventricle. Note that in the following description, this standard cross-section will be referred to as “A-plane”. Note that the control unit 40 may display the standard cross-section image that is acquired on the display unit 36.

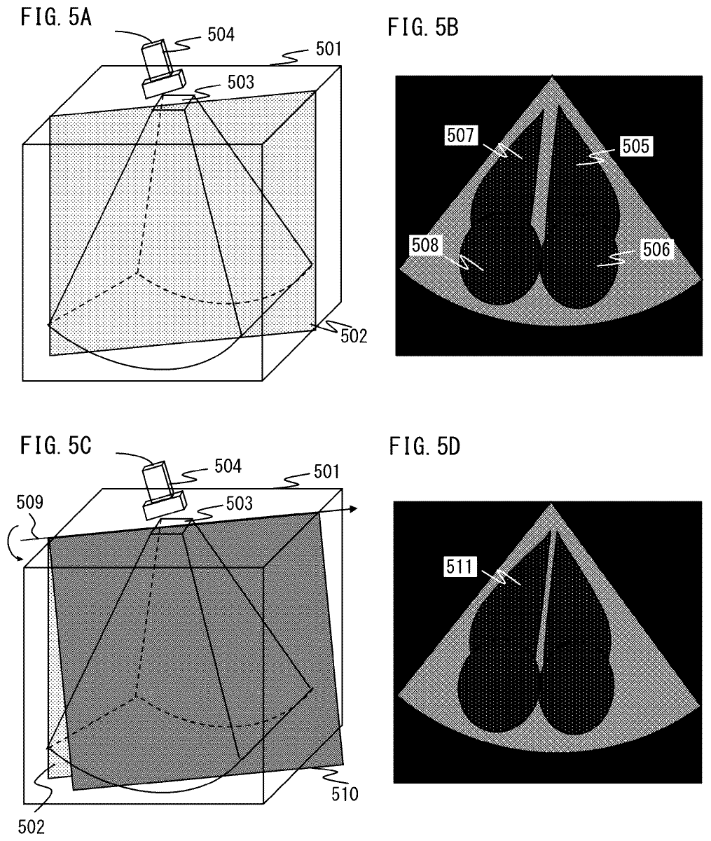

FIGS. 5A and 5B schematically illustrate the A-plane that is set in the three-dimensional ultrasound images of the heart, acquired in step S110, and the left ventricle, the left atrium, the right ventricle, and the right atrium, which are the cardiac chambers rendered within A-plane. FIG. 5A illustrates a three-dimensional ultrasound image 501 acquired in step S110, in which the heart is imaged, and the A-plane 502 that is the standard cross-section acquired in step S120. Also, FIG. 5A illustrates an imaging plane (hereinafter referred to as “probe plane”) 503 of the three-dimensional imaging probe 504 in the three-dimensional ultrasound image 501. Also, FIG. 5B illustrates a two-dimensional cross-section image of the A-plane 502. FIG. 5B illustrates each of the left ventricle 505, the left atrium 506, the right ventricle 507, and the right atrium 508, rendered on the A-plane 502.

In the present embodiment, the position of the three-dimensional imaging probe 504 in the three-dimensional ultrasound image 501 is identified based on image information that is imaged (angle of view, contour of visualized region, and so forth). Specifically, this can be identified from the imaging outline (fan-shaped in the case of the illustration) of the image (volume data, B-mode image, or the like) including the standard cross-section of the three-dimensional ultrasound image 501. Note that the position of the three-dimensional imaging probe 504 may be identified using Digital Imaging and Communications in Medicine (DICOM) information accessory to the three-dimensional ultrasound image 501, and position information (position specification information obtained from an examination order, information recorded by an image acquisition technologist, and so forth). The probe plane 503 in the three-dimensional ultrasound image 501 can then be identified based on the position of the three-dimensional imaging probe 504.

While the A-plane is used as the standard cross-section in the present embodiment, the standard cross-section may be another cross-section, in accordance with the purpose of observing the object. For example, a case in which the right ventricle is the object will be assumed. At this time a cross-section (two-chamber view) in which the cardiac apex portion of the right ventricle is rendered directly below the distal end of the probe, and the right ventricle and the right atrium are rendered in a positional relation that is approximately orthogonal to the A-plane, and also the size of the right ventricle is greatest (hereinafter referred to as “B-plane”), may be defined as the standard cross-section of the right ventricle.

(Step S130: Perform Training of Teacher Model) In step S130, the teacher dataset acquisition unit 43 acquires ground truth data that is information of the object in the standard cross-section image from the database 22, for each standard cross-section image acquired in step S120, and performs storage thereof in the storage unit 34. Accordingly, the teacher dataset acquisition unit 43 acquires the teacher dataset made up of sets, each of which includes a standard cross-section image and ground truth data (teacher data). In the present embodiment, the ground truth data is data indicating two-dimensional coordinate values of the contour point cloud disposed discretely, indicating the contour of the right ventricle in the A-plane cross-section image. Note that the teacher dataset acquisition unit 43 may acquire ground truth data by a method other than the method of acquiring from the database 22. For example, an arrangement may be made in which the image processing apparatus 10 sequentially acquires images that are imaged from time to time, the user operates the operating unit 35 to sequentially create ground truth data regarding the images that are acquired, and the teacher dataset acquisition unit 43 acquires the ground truth data created by the user.

Also, the teacher model training unit 44 performs training of a teacher model that is a learning model for estimating information of the object (coordinate values of the contour point cloud of the right ventricle) from the standard cross-section image using the teacher dataset acquired by the teacher dataset acquisition unit 43. The teacher model training unit 44 then saves the trained model that is obtained by training of the teacher model in the database 22 or the storage unit 34. In the present embodiment, a CNN is used for constructing the learning model, and for example a known network such as VGG-16, DenseNet, or the like, is used.

Note that in the present embodiment, the teacher model training unit 44 performs training of the learning model for estimating coordinate values of the contour point cloud of the right ventricle region, but training may be performed of a learning model for estimating coordinate values of the contour of another ventricle or atrium. Also, the teacher model training unit 44 is not limited to training a learning model that estimates coordinate values of a contour point cloud, and may train a learning model that estimates coordinate values for landmark positions, such as valves and so forth, included in the heart region.

(Step S140: Acquisition of Pseudo Standard cross-section Image) In step S140, the pseudo standard cross-section image acquisition unit 45 clips out and acquires pseudo standard cross-section images from each of the three-dimensional images acquired in step S110, using the standard cross-section parameters acquired in step S120 and the imaging plane of the three-dimensional imaging probe. Now, pseudo standard cross-section images are cross-sections that are different from the original standard cross-section, and are cross-sections that satisfy conditions of being spatially in the vicinity of the standard cross-section and also sharing the imaging plane of the three-dimensional imaging probe.

Acquisition of pseudo standard cross-section images according to the present embodiment will be described with reference to FIGS. 5C and 5D. First, FIG. 5C illustrates the three-dimensional ultrasound image 501 and the A-plane 502 illustrated in FIG. 5A. The pseudo standard cross-section image acquisition unit 45 calculates a line of intersection 509 of the probe plane 503 and the A-plane 502 illustrated in FIG. 5C, using the standard cross-section parameters acquired in step S120. Here, the line of intersection 509 is orthogonal to an irradiation direction of an unshown ultrasound beam irradiated from the probe plane 503 by the three-dimensional imaging probe 504. Next, the pseudo standard cross-section image acquisition unit 45 varies the standard cross-section parameters of the A-plane so as to rotate the A-plane 502 by a predetermined angle, with the line of intersection 509 that is calculated as an axis of rotation, thereby calculating pseudo standard cross-section parameters. Now, pseudo standard cross-section parameters are parameters expressed by the same expression form as the standard cross-section parameters acquired in step S120. The pseudo standard cross-section image acquisition unit 45 then uses the pseudo standard cross-section parameters that are calculated to acquire a cross-section image clipped out from the three-dimensional ultrasound image 501 of the heart as a pseudo standard cross-section image 510.

Specifically, the pseudo standard cross-section image acquisition unit 45 acquires a plurality of pseudo standard cross-section images by rotating the A-plane 502 by a predetermined step size within a predetermined angle range, with the line of intersection 509 as the axis of rotation. For example, the pseudo standard cross-section image acquisition unit 45 acquires twenty images of pseudo standard cross-sections obtained by rotating the A-plane in increments of 1° over a range of 10° about the axis of rotation (ten images obtained by rotating in the positive direction of the angle of rotation, and ten images obtained by rotating in the negative direction of the angle of rotation).

Note that this angle range for rotating the standard cross-section is only an example. For example, an angle range of error in standard cross-section parameters generating when a plurality of physicians and technologists set the standard cross-section (error arising between examiners) in the image processing apparatus 10 may be employed as the above angle range. Also, the number of pseudo standard cross-section images obtained by the pseudo standard cross-section image acquisition unit 45 may be a number that is appropriate for the number of images to be used for training of a student model, which will be described later. Also, while a plurality of pseudo standard cross-sections are acquired by rotating the rotational angle of the standard cross-section by the predetermined step size in the above-described example, the present embodiment is not limited to this, and rotation angles within a predetermined angle range set using random numbers or the like may be used, for example. In this case, the rotation angle can be generated as a uniform distribution or generated as a normal distribution, using random numbers or the like. Accordingly, the pseudo standard cross-section image acquisition unit 45 acquires images, including cross-section images at cross-sections other than cross-sections in which the orientation of the standard cross-section is rotated with the irradiation direction of the ultrasound beam irradiated from the three-dimensional imaging probe as the axis, as pseudo standard cross-section images.

According to the method described above, the pseudo standard cross-section image acquisition unit 45 can acquire the pseudo standard cross-section image 510 in which the right ventricle 511 is rendered as a cross-section that is different from the A-plane 502, as illustrated in FIG. 5D.

In ultrasound cardiogram examinations, a position at which the three-dimensional imaging probe 504 is pressed against the subject in order to perform imaging of three-dimensional ultrasound images of the heart is set in advance regarding each imaging object (e.g., cardiac apex, left parasternal, subcostal, and so forth). Accordingly, in a three-dimensional ultrasound image that is acquired for observing the right ventricle of the heart, for example, a positional relation between the standard cross-section that is a standard cross-section for observing the right ventricle and the imaging plane of the three-dimensional imaging probe is fixed to a certain extent. In the present embodiment, the standard cross-section is rotated with the position of the imaging plane of the three-dimensional imaging probe as a reference by the pseudo standard cross-section image acquisition unit 45 in accordance with the above processing, thereby acquiring pseudo standard cross-sections. Thus, according to the image processing apparatus 10, pseudo standard cross-sections that can be acquired by manipulation with intent of rendering of the standard cross-section (i.e., can be input at the time of estimating the contour point cloud of the right ventricle) can be acquired.

Note that while cross-sections in which the A-plane is rotated with the line of intersection of the probe plane and the A-plane as the axis of rotation are used as pseudo standard cross-sections in the present embodiment, the rotation method of the A-plane in the present embodiment is not limited to this. For example, the pseudo standard cross-section image acquisition unit 45 may acquire a cross-section in which the A-plane is translated as a pseudo standard cross-section. For example, the pseudo standard cross-section image acquisition unit 45 can perform translation of the A-plane while maintaining a state in which an upper side of the cross-section is situated in the plane of the probe plane 503. In this case, the probe plane 503 is the imaging plane of the three-dimensional imaging probe 504 and at the same time also is a position on the body surface of the subject. Accordingly, performing translation of the A-plane in-plane the probe plane 503 enables translation of the A-plane within the range of movement of the three-dimensional imaging probe 504 on the body surface of the subject, without moving the three-dimensional imaging probe 504. Accordingly, the pseudo standard cross-section image acquisition unit 45 can acquire a cross-section that has a higher likelihood of being a cross-section obtained from an image that is imaged by the three-dimensional imaging probe 504, as the pseudo standard cross-section.

Also, the pseudo standard cross-section image acquisition unit 45 may perform calculations using random numbers or the like regarding the center of rotation about which the A-plane rotates, such that the center of rotation is set in the vicinity of the probe position on the A-plane with a higher frequency, and acquire cross-sections from rotation about the position of calculation as pseudo standard cross-sections. Specifically, the pseudo standard cross-section image acquisition unit 45 decides the center of rotation using a probability distribution in which the probability of the center of rotation on which the A-plane is rotated being set in the vicinity of the probe position is high, and acquires cross-sections from rotation of the A-plane about the center of rotation that is decided as pseudo standard cross-sections. Thus, the positional relation between the three-dimensional imaging probe 504 and the subject in the pseudo standard cross-section image is limited to a relation that is suitable for estimation of the contour point cloud of the right ventricle, whereby suitable pseudo standard cross-section images are obtained by estimation using a learning model.

(Step S150: Generation of Pseudo Correct Answer Data) In step S150, the pseudo ground truth data acquisition unit 46 estimates information of the object by applying the trained model obtained by training in step S130 to each of the pseudo standard cross-section images acquired in step S140. The pseudo ground truth data acquisition unit 46 then acquires information of the object that is estimated as pseudo ground truth data. In the present embodiment, the pseudo ground truth data acquisition unit 46 estimates the two-dimensional coordinate values of the contour point cloud of the right ventricle in the pseudo standard cross-section images by a trained model that performed training using the teacher model, and acquires the coordinate values that are estimated as pseudo ground truth data.

(Step S160: Training of Student Model) In step S160, the pseudo teacher dataset acquisition unit 47 creates pseudo teacher data that is a set of the pseudo standard cross-section images acquired in step S140 and the pseudo ground truth data generated in step S150. The pseudo teacher dataset acquisition unit 47 then acquires a pseudo teacher dataset made up of a plurality of pieces of pseudo teacher data. The student model training unit 48 then uses the teacher dataset acquired in step S130 and the pseudo teacher dataset to train the student model, which is a learning model for estimating information of the object from the standard cross-section image. The student model training unit 48 then saves the trained model obtained by training of the student model in the database 22 or the storage unit 34.

In the present embodiment, training is performed for a student model that is a learning model that estimates coordinate values of a contour point cloud of the right ventricle from cross-section images of the right ventricle, using a pseudo teacher dataset made up of a set of pseudo standard cross-section images of the right ventricle and coordinate values of a contour point cloud of the right ventricle that are pseudo ground truth data. Note that a model structure of the student model may be the same as that of the teacher model, or a model may be used that has a different structure from the teacher model.

Description has been made in the present embodiment regarding a case of training of a student model using only a pseudo teacher dataset made up of the pseudo standard cross-section images and pseudo ground truth data that are acquired by the processing of step S140 and step S150. However, note that the training method of the student model according to the present embodiment is not limited to this. For example, in the training of the student model above, the student model training unit 48 may perform training of the student model using data acquired by known data enhancement techniques as well. Specifically, the pseudo standard cross-section image acquisition unit 45 performs processing of translation, rotation, scaling, linear transformation of pixel values, noise impartation, and so forth, with respect to standard cross-section images, by a method different from that of step S140, thereby acquiring second pseudo standard cross-section images that are different from the above pseudo standard cross-sections. More specifically, the pseudo standard cross-section image acquisition unit 45 performs translation, rotation, scaling, and so forth, within the plane of the standard cross-section, rotates the standard cross-section with the irradiation direction of the ultrasound beam irradiated from the three-dimensional imaging probe as an axis, or the like. The pseudo standard cross-section image acquisition unit 45 then acquires pseudo ground truth data (second pseudo ground truth data) by subjecting the second pseudo standard cross-section images to a known technique that is different from that of step S150. The pseudo teacher dataset acquisition unit 47 then creates second pseudo teacher data that is a set of the second pseudo standard cross-section images and the second pseudo ground truth data, and acquires a second pseudo teacher dataset made up of a plurality of pieces of second pseudo teacher data. Thus, the student model training unit 48 learns the student model using the pseudo teacher dataset and the second pseudo teacher dataset.

Training of the student model is preferably performed such that the effects on training the student model are greater for the pseudo teacher dataset acquired by the processing of step S140 and step S150 as compared to that of the second pseudo teacher dataset obtained by the known data enhancement technique. Specifically, for example, a greater count of pseudo teacher data is acquired by the processing of step S140 and step S150 as compared to the count of the second pseudo teacher data obtained by the known data enhancement technique. Separately, weighting in the training of the student model (more specifically, weighting at the time of calculating loss functions) may be made to differ between the second pseudo teacher data obtained by the known data enhancement technique, and that of the pseudo teacher data obtained by the processing of step S140 and step S150. In this case, the weighting of the pseudo teacher data acquired by the processing of step S140 and step $150 is made to be greater than the weighting of the second pseudo teacher dataset obtained by the known data enhancement technique. Accordingly, the student model training unit 48 can include pseudo teacher datasets acquired by other methods as well, while keeping the effects of the pseudo teacher dataset acquired by the processing of step S140 and step S150 to be dominant with respect to the training of the student model. As a result, the student model training unit 48 can acquire a trained model that is more robust, through training of the student model.

Note that in the present embodiment, estimation processing of the object may further be performed, using the trained model obtained by training of the above student model, with unknown cross-section images as input. Specifically, the control unit 40 functions as an input image acquisition unit, clips out an image of the A-plane from a three-dimensional ultrasound image of the heart imaged in an ultrasound cardiogram examination, as a standard cross-section, and acquires the image that is clipped out as an input image. The control unit 40 then functions as an estimating unit, inputs the input image that is acquired to the trained model obtained by training of the student model according to the method described above, and performs estimation of coordinate values of the contour point cloud of the right ventricle. Also, the control unit 40 may display the A-plane image that is the input image on the display unit 36, and superimpose coordinate values of a contour point cloud that are estimated on the A-plane image.

Thus, according to the processing of the image processing apparatus 10 of the present embodiment, training can be performed of a learning model that is capable of estimating, with good precision, two-dimensional coordinate values of the contour point cloud of the right ventricle that is the object from a standard cross-section image in three-dimensional ultrasound image of the heart. Acquiring pseudo standard cross-sections based on the relation between the imaging plane of the three-dimensional imaging probe and the standard cross-section enables pseudo standard cross-section images, such that the position and the orientation of the subject in the pseudo standard cross-section images are suitable, to be provided for augmentation of data used for training of the learning model. Also, according to the image processing apparatus 10, pseudo ground truth data for the pseudo standard cross-section images is created using the trained model obtained by training of the teacher model with the teacher dataset. Accordingly, in the image processing apparatus 10, the above pseudo teacher dataset is acquired regarding cross-section images other than standard cross-sections, for which there originally is no ground truth data, and training of the student model is performed, and accordingly it is anticipated that a trained model with even higher estimation precision of the contour point cloud of the right ventricle can be obtained.

Modifications of the embodiment above will be described below. Note that in the description below, configurations and processing that are the same as the configurations and the processing of the image processing system 1 according to the above embodiment will be denoted by the same signs, and detailed description will be omitted.

### Modification 1-1

While a case is assumed in the first embodiment in which three-dimensional ultrasound images imaged in an ultrasound cardiogram examination are the object of processing, the above embodiment is also applicable to cases of using images imaged by a three-dimensional imaging probe in an ultrasound examination of other than the heart, as in the present embodiment.

For example, a case is assumed in which, in the image processing apparatus 10, a standard cross-section image of the head of a fetus is acquired, with a three-dimensional ultrasound image in which the fetus is imaged as an input image. Specifically, the standard cross-section image acquisition unit 42 clips out and acquires a standard cross-section image of the head of the fetus from standard cross-section parameters of the head, in a three-dimensional ultrasound image obtained by imaging the fetus using the three-dimensional imaging probe. The teacher model training unit 44 then performs training of the teacher model with the standard cross-section image that is acquired as teacher data, and also the contour point cloud of the head region in the standard cross-section image as ground truth data.

Next, the pseudo standard cross-section image acquisition unit 45 acquires cross-sections obtained by rotating the standard cross-section of the head, with the line of intersection between the probe plane and the standard cross-section of the head in the three-dimensional ultrasound image of the fetus as the axis of rotation, as pseudo standard cross-section images of the head. The pseudo ground truth data acquisition unit 46 then inputs the pseudo standard cross-section images of the head to the trained model obtained by the teacher model performing training, estimates coordinate values of the contour point cloud of the head region, and acquires the coordinate values of the contour point cloud that are estimated as pseudo ground truth data. The pseudo teacher dataset acquisition unit 47 uses a set of pseudo standard cross-section images and pseudo ground truth data to create a pseudo teacher dataset. The student model training unit 48 then trains the student model using the pseudo teacher dataset. Accordingly, the image processing apparatus 10 according to the present modification can augment learning data for the learning model used for estimation of the coordinate values of the contour point cloud in the head region, in the standard cross-section image of the head of the fetus.

Note that in the image processing apparatus 10 according to the present modification, sites of the heart of the subject other than the right ventricle, such as for example, the left ventricle, the left atrium, the aortic valve, the mitral valve, and so forth may be taken as the object, and training of the teacher model and the student model can be performed by processing that is the same as above.

### Modification 1-2

A case is assumed in the first embodiment in which an estimator based on deep learning such as CNN or the like is used as the estimator to realize the teacher model and the student model. However, an estimator based on deep learning other than CNN, such as Vision Transformer or the like, for example, may be used, as in the present modification. In the present modification as well, training of the teacher model and the student model can be performed in the image processing apparatus 10 by processing that is the same as the first embodiment.

Alternatively, an estimator may be used in the image processing apparatus 10 based on known machine learning techniques other than deep learning, such as recursion using Random Forest or AdaBoost, and so forth. In this case as well, training of the teacher model and the student model can be performed in the image processing apparatus 10 by processing that is the same as the first embodiment.

### Modification 1-3

A case is assumed in the first embodiment in which training is performed of a learning model that takes a standard cross-section image of the right ventricle in three-dimensional ultrasound images imaged in the ultrasound cardiogram examination as input, and outputs coordinate values of the contour point cloud of the right ventricle. However, the above embodiment is also applicable to cases of performing training of a learning model that estimates information other than coordinate values of the contour point cloud of the object in the standard cross-section image, as in the present modification.

In the present embodiment, a case of estimating a region relating to the object from the standard cross-section image is assumed, for example. Specifically, a case of taking the standard cross-section of the right ventricle in a three-dimensional ultrasound image of the heart as input, and extracting the region of the right ventricle in this image can be given as an example. The processing procedures in this case will be described. First, training of the teacher model is performed with a standard cross-section image of the right ventricle that is clipped out from the three-dimensional ultrasound image of the heart using standard cross-section parameters, and information of the region of the right ventricle that is ground truth data, as teacher data. The information of the region of the right ventricle here can be given in the form of a mask image, for example. Next, pseudo standard cross-section images are clipped out and acquired from the three-dimensional ultrasound image by the same method as that in the first embodiment. The right ventricle region in the pseudo standard cross-section images is then estimated using the teacher model. The region acquired by estimation is used as pseudo ground truth data to create pseudo teacher data, and training of the student model is performed using a pseudo teacher dataset.

Note that a mask image representing the right ventricle region that is ground truth data or pseudo ground truth data can be expressed by binary values for each pixel (e.g., 1 is for a pixel representing right ventricle and 0 is for a pixel representing a portion other than right ventricle). Also, regarding the pseudo ground truth data, the right ventricle region may be an image in which pixel values are values of likelihood expressed by 0 to 1, estimated by the teacher model, instead of the binary mask image described above. The pseudo ground truth data is obtained by estimation using the teacher model, unlike the ground truth data that has been accurately annotated by a physician or a technologist. Accordingly, there is a possibility that a region obtained by estimation may include inappropriate regions (erroneous detection regions or overlooked regions) for the right ventricle. Using an image in which the values of likelihood estimated by the teacher model as pixel values as pseudo ground truth data enables the effects that regions with low likelihood, which are possibly inappropriate as the right ventricle, will have on training, to be reduced. Thus, according to the present modification, the above embodiment can also be applied to cases of extracting the region of the object in the standard cross-section image.

### Modification 1-4

A case is assumed in the first embodiment in which training is performed of a learning model that estimates coordinate values of the contour point cloud that represents the contour shape of the right ventricle, taking a standard cross-section image of the right ventricle in ultrasound cardiogram images imaged in an ultrasound cardiogram examination as input. However, the above embodiment is also applicable to training of learning models that estimate features other than the contour of the object in the standard cross-section image, as in the present modification.

In the present modification, a case is assumed in which a cross-section type of a standard cross-section image clipped out from a three-dimensional ultrasound image of the heart, for example, is estimated (identified). Estimating (identifying) the cross-section type here means to estimate the cross-section type of the standard cross-section image of the heart, which is an input image to the learning model. Examples of cross-section types of standard cross-section images include apical four chamber view (hereinafter, “four chamber view”), apical two chamber view (hereinafter, “two chamber view”), apical three chamber view (hereinafter, “three chamber view”), transthoracic short axis view (hereinafter, “short axis view”), transthoracic long axis view (hereinafter, “long axis view”), and so forth. The apical four chamber view is a cross-section in which the four chambers of the left ventricle, the left atrium, the right ventricle, and the right atrium, are rendered. The apical two chamber view is a cross-section in which the two chambers of the left ventricle and the left atrium are rendered. The apical three chamber view is a cross-section in which the left ventricle, the left atrium, and the right ventricle, are rendered. The transthoracic short axis view is a cross-section orthogonal to a long axis connecting a left ventricular outflow tract and an apical position. The transthoracic long axis view is a cross-section following the long axis connecting the left ventricular outflow tract and the apical position.

In the present modification, a case is assumed of estimating which of the four chamber view, two chamber view, three chamber view, short axis view, and long axis view, the cross-section type of the standard cross-section image is. In the estimation of the cross-section type, likelihood that is represented from 0 to 1 is calculated for each cross-section type, and the cross-section type of which the likelihood is calculated to be is the highest is decided as being the cross-section type of the standard cross-section image. In the same way as in the embodiment above, the teacher model training unit 44 performs training of the teacher model, with a standard cross-section image acquired from the three-dimensional ultrasound image of the heart using the standard cross-section parameters, information representing the cross-section type of the cross-section, as teacher data.

The pseudo standard cross-section image acquisition unit 45 then acquires pseudo standard cross-section images by the same method as in the first embodiment. The pseudo teacher dataset acquisition unit 47 inputs the pseudo standard cross-section images into the teacher model and estimates the cross-section type, and acquires the cross-section type that is estimated as pseudo ground truth data. The pseudo teacher dataset acquisition unit 47 then creates pseudo teacher data made up of a set of the pseudo standard cross-section images and the pseudo ground truth data, and acquires a pseudo teacher dataset using a plurality of pieces of pseudo teacher data. The student model training unit 48 performs training of the student model using the pseudo teacher dataset.

Note that the cross-section type in the ground truth data can be expressed by binary values (e.g., in a case in which the cross-section type is four chamber view, output values corresponding to the four chamber view are 1, and output values corresponding to another cross-section type are 0). However, note that the cross-section types in the pseudo ground truth data is not limited to being expressed in binary, and values of likelihood expressed by 0 to 1, estimated for each cross-section type, may be used. The ground truth data is data based on likelihood that is obtained by estimation using the teacher model, unlike the ground truth data that has been accurately annotated by a physician or a technologist. Accordingly, there is a possibility that the ground truth data may represent an inappropriate cross-section type. In the present modification, it can be anticipated that further performing training of the student model using the likelihood of the cross-section type estimated by the teacher model as pseudo ground truth data will enable the effects that cross-section types with low likelihood will have on training of the learning model to be reduced.

### Modification 1-5

A case is assumed in the first embodiment in which training is performed of a student model that takes a standard cross-section image of the right ventricle acquired from a three-dimensional ultrasound image of the heart as input, and estimates coordinate values of the contour point cloud of the right ventricle. However, information of the object by a student model that has performed training by the same method as in the first embodiment can be estimated, using an unknown standard cross-section image regarding which whether information of the object exists or not is unknown, as in the present modification.

In the present modification, an unknown standard cross-section image is input to a trained model obtained by performing training of a student model by the same method as in the first embodiment, and information of the object is estimated. As an example, in the image processing apparatus 10, a standard cross-section image of the right ventricle that is acquired from a three-dimensional ultrasound image of the heart is input to the student model, and coordinate values of the contour point cloud of the right ventricle are estimated.

In the present modification, the student model training unit 48 acquires a trained model by performing training of a student model by the method described in the first embodiment. The standard cross-section image acquisition unit 42 acquires a standard cross-section image of the right ventricle from a three-dimensional ultrasound image in which the coordinate values of the contour point cloud of the right ventricle are unknown. Now, the user can operate the operating unit 35 to specify a standard cross-section image of the right ventricle from the three-dimensional ultrasound image of the heart, or the control unit 40 can identify the standard cross-section image from the three-dimensional ultrasound image by estimation using a trained model that estimates the standard cross-section parameters of the right ventricle. The control unit 40 can then input the standard cross-section image that is acquired to the trained model obtained by performing training of the student model, and estimate the coordinate values of the contour point cloud of the right ventricle.

Note that the unknown standard cross-section image in the present modification does not necessarily have to be an image clipped out and acquired from a three-dimensional ultrasound image of the heart, and may be a two-dimensional ultrasound image that is acquired by the user imaging a standard cross-section of the subject.

Also, the same apparatus does not necessarily have to execute the processing of training the student model by the method described in the first embodiment and the estimating processing using the unknown standard cross-section image, and these may be executed by different apparatuses. In this case, for example, the trained model obtained by performing training of the student model by the processing above is recorded in an optional recording apparatus by an apparatus that is different from the image processing apparatus 10. Accordingly, the image processing apparatus 10 can acquire the trained model recorded in the recording apparatus, and use the trained model that is acquired to execute processing of estimating information of the object in the unknown standard cross-section image by the above processing.

### Modification 1-6

A case is assumed in the first embodiment in which a learning model is acquired by executing the processing of step S110 to step S160. However, after performing training of the student model by the processing of step S110 to step S160 in the image processing apparatus 10, the processing of step S140 and thereafter may be executed again, as in the present modification, for example. In this case, the learning model used for generating the pseudo ground truth data in step S150 that is executed again is not the teacher model obtained in step S130 but is the student model already acquired in step S160.

Accordingly, in the image processing apparatus 10 according to the present embodiment, at the time of executing step S160 again, performing training of the student model used in the previous step S160 using the pseudo ground truth data that is generated enables updating to a trained model with even higher estimation precision. That is to say, repeatedly executing the processing of step S140 to step S160 in the image processing apparatus 10 in addition to the processing described in the first embodiment enables the trained model based on the student model to be updated. Accordingly, acquisition of a trained model that generates pseudo ground truth data with higher precision of information of the object, thereby improving estimation precision of information of the object, can be anticipated.

### Modification 1-7

In the processing of step S150, the pseudo ground truth data acquisition unit 46 according to the present modification uses the same data as the ground truth data of the standard cross-section image, for the pseudo ground truth data that is the ground truth data for the pseudo standard cross-section images. In this case, the acquisition processing of the teacher model performed in step S130 can be omitted.

According to the image processing apparatus 10 of the present modification, by acquiring pseudo standard cross-section images based on the relation between the imaging plane of the three-dimensional imaging probe and the standard cross-section, pseudo standard cross-section images such that the position and the orientation of the subject in the pseudo standard cross-section images are suitable can be augmented as data for use in training of the learning model. Also, learning data used in training of the teacher model can be augmented and estimation precision of the teacher model and the student model that estimate information of the object can be improved, without creating pseudo ground truth data using the teacher model.

### Second Embodiment

Next, an image processing system according to a second embodiment will be described. Note that in the description below, configurations and processing that are the same as the configurations and the processing of the first embodiment will be denoted by the same signs, and detailed description will be omitted.

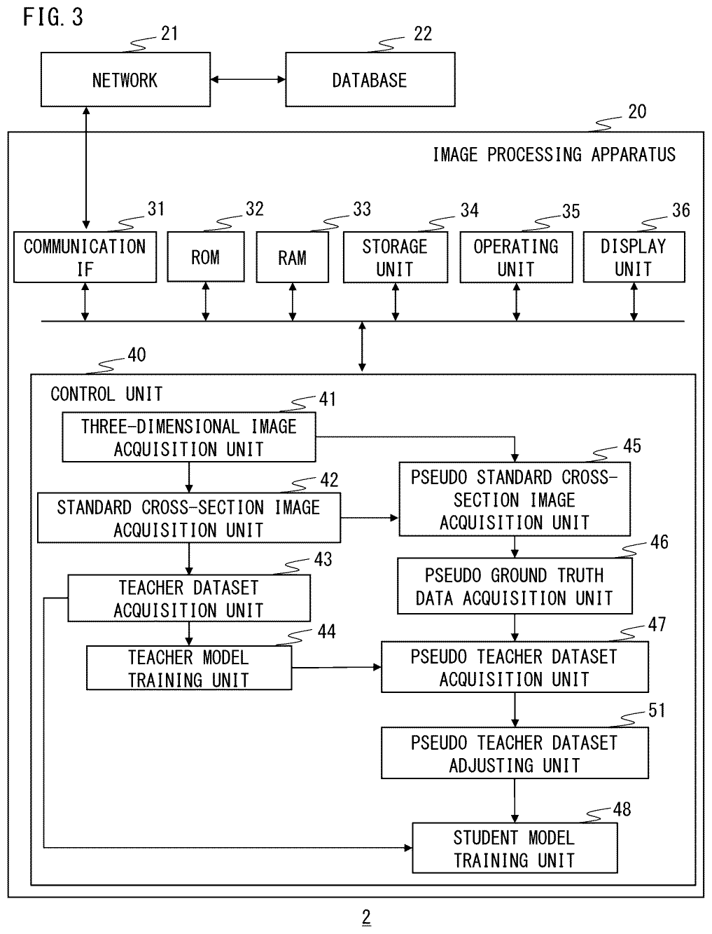

FIG. 3 illustrates a schematic configuration of the image processing system 2 according to the present embodiment. As illustrated in FIG. 3, the image processing system 2 has an image processing apparatus 20 and the database 22. The image processing apparatus 20 according to the present embodiment differs from the image processing apparatus 10 according to the first embodiment illustrated in FIG. 1 with respect to the point of having a pseudo teacher dataset adjusting unit 51. Description will be made below primarily regarding points of difference in processing that the units of the image processing apparatus 20 execute as to the processing contents of the first embodiment.

The image processing apparatus 20 according to the second embodiment trains a learning model that estimates coordinate values of a contour point cloud of an object, from a standard cross-section in a three-dimensional image obtained by performing imaging of the object using a three-dimensional imaging probe, in the same way as in the first embodiment. The image processing apparatus 10 according to the first embodiment trains the student model using a pseudo teacher dataset made up of pseudo teacher data that is generated, for example, without performing any particular screening processing or the like on the data that is used in training of the learning model. Conversely, the image processing apparatus 20 according to the present embodiment determines whether or not the pseudo ground truth data estimated using the trained model obtained by training of the teacher model is suitable as ground truth data to be used for training of the student model. The image processing apparatus 20 then acquires a set of pseudo ground truth data that has been determined to be suitable as ground truth data to be used for training the student model, and pseudo standard cross-section images corresponding to the pseudo ground truth data, as pseudo teacher data. The image processing apparatus 20 also generates a pseudo teacher dataset using a plurality of pieces of the pseudo teacher data that are acquired.

In the present embodiment, a case is assumed of training a learning model that estimates two-dimensional coordinate values of a contour point cloud making up a contour of the right ventricle in a standard cross-section, taking a standard cross-section image of the right ventricle clipped out from a three-dimensional ultrasound image of the heart as an input image, in the same way as in the first embodiment.

In the present embodiment, the pseudo teacher dataset adjusting unit 51 determines whether or not the pseudo teacher data contained in the pseudo teacher dataset acquired by the pseudo teacher dataset acquisition unit 47 is appropriate as data to be used for training of the student model. The pseudo teacher dataset adjusting unit 51 then excludes pseudo teacher data, which has been determined to be inappropriate as data to be used for training of the student model, from the pseudo teacher dataset. That is to say, the pseudo teacher dataset adjusting unit 51 adjusts the pseudo teacher dataset acquired by the pseudo teacher dataset acquisition unit 47 such that the pseudo teacher dataset is made up just of data that is appropriate as pseudo teacher data to be used for training of the student model.

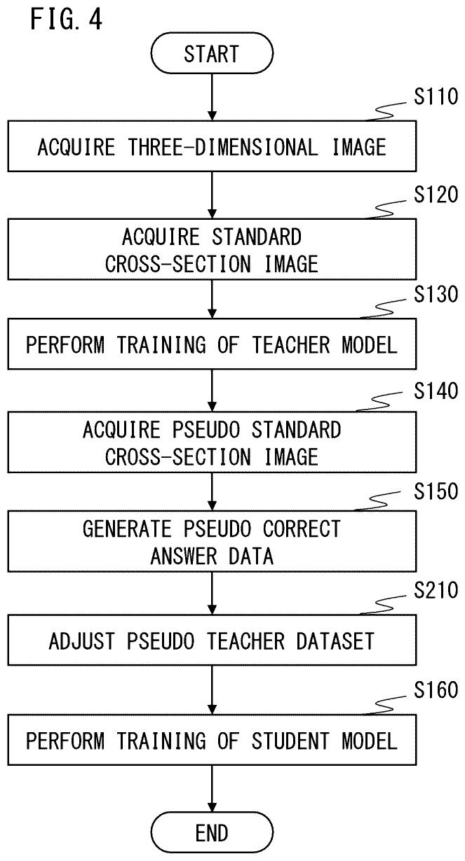

Next, an example of processing executed by the image processing apparatus 20 will be described in detail with reference to the flowchart in FIG. 4. As shown in FIG. 4, processing of step S210 for adjusting the pseudo teacher dataset is added to the processing executed by the image processing apparatus 10 in the first embodiment shown in FIG. 2. Hereinafter, differences of the processing steps executed by the image processing apparatus 20, as to the processing contents of the first embodiment, will be described in detail.

(Step S210: Adjusting Pseudo Teacher Dataset) In step S210, the pseudo teacher dataset adjusting unit 51 determines whether or not the pseudo ground truth data generated in step S150 is appropriate data, based on the standard cross-section image acquired in step S120 and features of the ground truth data generated in step S130. The pseudo teacher dataset adjusting unit 51 is a determining unit that determines, for each piece of pseudo teacher data, whether or not the pseudo ground truth data is data in which information of the object in the pseudo standard cross-section image has been appropriately estimated. In a case of determining that the pseudo teacher data is not appropriate data, the pseudo teacher dataset adjusting unit 51 then excludes this pseudo teacher data from the pseudo teacher dataset. Accordingly, the pseudo teacher data that is excluded is not used for training the student model in step S160.

In the present embodiment, in step S210 the pseudo teacher dataset adjusting unit 51 determines, for each of the coordinate values of the contour point cloud of the right ventricle estimated using the pseudo standard cross-section images, whether or not the coordinate value indicates an appropriate position, based on pixel values in the vicinity of this coordinate value. For example, the pseudo teacher dataset adjusting unit 51 calculates, from the pixel values in the vicinity of a position indicated by the coordinate value of the contour point that is estimated, an edge intensity of this position. The pseudo teacher dataset adjusting unit 51 then determines that the pseudo teacher data used for estimating this coordinate value is inappropriate data in a case in which the edge intensity that is calculated is lower than a predetermined threshold value. In this case, the pseudo teacher dataset adjusting unit 51 can calculate the edge intensity based on spatial gradient of pixel values.

More specifically, the pseudo teacher dataset adjusting unit 51 calculates a contour line from the coordinate values of the contour point cloud that is estimated, i.e., a line connecting adjacent contour points to each other. The pseudo teacher dataset adjusting unit 51 then calculates the edge intensity based on the spatial gradient of the pixel values in a direction orthogonal to the contour line. Separately, the pseudo teacher dataset adjusting unit 51 calculates, for example, the edge intensity at a plurality of positions in the direction orthogonal to the contour line, and determines whether or not a position at which the edge intensity becomes a predetermined edge intensity or higher is a predetermined distance away from the contour line. The pseudo teacher dataset adjusting unit 51 then determines that the pseudo teacher data used for calculation of the contour line is inappropriate data in a case of determining that the position at which the edge intensity becomes the predetermined edge intensity or higher is the predetermined distance away from the contour line.

Alternatively, the pseudo teacher dataset adjusting unit 51 may perform determination of the pseudo teacher data based on positional relation among contour points, such as a curvature or the like of the contour line calculated using the coordinate values of the contour point cloud that is estimated. Specifically, the pseudo teacher dataset adjusting unit 51 calculates, for each contour point, a curvature based on a relation in position as to adjacent contour points on both sides. The pseudo teacher dataset adjusting unit 51 then determines that the pseudo teacher data used for calculation of the curvature is appropriate data in a case in which the curvature that is calculated does not diverge from a distribution of curvature of ground truth data and is within a certain range. The pseudo teacher dataset adjusting unit 51 also determines that the pseudo teacher data used for calculation of the curvature is inappropriate data in a case in which the curvature that is calculated is outside of the certain range in the distribution of curvature of ground truth data.

Note that instead of the above, determination of whether or not the coordinate values of the contour point cloud of the right ventricle that is estimated indicate an appropriate position can be performed by a user, such as a physician, technologist, or the like, visually confirming the ground truth data. For example, the control unit 40 displays pseudo teacher data on the display unit 36, and the user operates the operating unit 35 to input determination results (whether appropriate or inappropriate) regarding the pseudo teacher data displayed on the display unit 36. In a case in which the determination results of the user that are input indicate that the pseudo teacher data is “appropriate” data, the pseudo teacher dataset adjusting unit 51 then includes this pseudo teacher data in the pseudo teacher dataset. Conversely, in a case in which the determination results of the user that are input indicate that the pseudo teacher data is “inappropriate” data, the pseudo teacher dataset adjusting unit 51 excludes this pseudo teacher data from the pseudo teacher dataset. Thus, the pseudo teacher dataset adjusting unit 51 can adjust the pseudo teacher dataset based on visual confirmation by the user.

Also, instead of the above, determination of whether or not the coordinate values of the contour point cloud of the right ventricle that is estimated indicate an appropriate position can be performed using a determiner obtained by machine learning. Specifically, a discriminator that estimates whether or not contour points that are input are appropriate for a contour as likelihood, is trained in advance, with coordinate values of contour points being taken as input. The pseudo teacher dataset adjusting unit 51 then inputs the pseudo teacher data into the discriminator that is trained, and can determine that the coordinate values of the contour point cloud made up of the contour points indicate appropriate positions in a case in which the positions of the contour points of the object that the pseudo ground truth data indicates have a predetermined likelihood or higher.

Also, instead of the above, determination of whether or not the coordinate values of the contour point cloud of the right ventricle that is estimated indicate appropriate positions may be performed based on the ground truth data acquired in step S130. For example, the pseudo teacher dataset adjusting unit 51 can determine whether or not the coordinate values of the contour point cloud of the pseudo ground truth data indicate appropriate positions by using the coordinate values of the contour point cloud of the right ventricle in the standard cross-section image of the three-dimensional ultrasound image, which is an acquisition source of the pseudo standard cross-section images.

For example, the pseudo teacher dataset adjusting unit 51 determines whether or not the pixel values of positions indicated by the coordinate values of the contour point cloud of the pseudo ground truth data in the pseudo standard cross-section images are within a predetermined range from the distribution of pixel values in the vicinity of a position indicated by coordinate values of the contour point cloud of the right ventricle in the standard cross-section image. In a case in which the pixel values of a position indicated by coordinate values of the contour point cloud of the pseudo ground truth data are within a predetermined range from the distribution of the pixel values, the pseudo teacher dataset adjusting unit 51 then determines that the coordinate values indicate an appropriate position. The pseudo teacher dataset adjusting unit 51 then includes the pseudo teacher data used to estimate the coordinate values determined to indicate the appropriate position in the pseudo teacher dataset. Also, pseudo teacher data used to estimate coordinate values determined to not indicate an appropriate position are excluded from the pseudo teacher dataset.

Note that in the present embodiment, estimation processing of the object may further be performed, using the trained model obtained by training of the above student model, with unknown cross-section images as input, in the same way as in the first embodiment. Specifically, the control unit 40 clips out an image of the A-plane from a three-dimensional ultrasound image of the heart imaged in an ultrasound cardiogram examination, as a standard cross-section, and acquires this as an input image. Next, the input image that is acquired is input to the trained model obtained by training of the student model in step S160, and estimation of coordinate values of the contour point cloud of the right ventricle can be performed. Also, the control unit 40 may display an A-plane image that is the input image on the display unit 36, and superimpose coordinate values of a contour point cloud that are estimated on the A-plane image.

According to the processing as described above performed by the image processing apparatus in the present embodiment, it can be achieved to train student models that more accurately estimate the coordinates of the right ventricular contour point cloud by using only pseudo teacher data appropriate for training the student models.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire apparatus.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the technology of the present disclosure, the estimation precision of information relating to objects from images in which a subject is imaged, can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113658, filed on Jul. 16, 2024, which is hereby incorporated by reference herein in its entirety.

What is claimed is:

1. An image processing apparatus, comprising:
an image acquisition unit that acquires a standard cross-section image, which is an image of a standard cross-section, from a three-dimensional image including an object;
a teacher data acquisition unit that acquires teacher data including the standard cross-section image and ground truth data that is information regarding the object in the standard cross-section image;
a first learning unit that constructs a first learning model by performing training of the teacher data;
a pseudo standard cross-section image acquisition unit that acquires, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image;
a pseudo ground truth data acquisition unit that acquires pseudo ground truth data that is information of the object in the pseudo standard cross-section image, using the first learning model; and
a second learning unit that constructs a second learning model by performing training of pseudo teacher data including the pseudo standard cross-section image and the pseudo ground truth data. 2 The image processing apparatus according to claim 1, wherein
the teacher data acquisition unit acquires information relating to a shape of a predetermined site of the object in the standard cross-section, as information of the object, and
the pseudo ground truth data acquisition unit acquires information relating to the shape of the predetermined site of the object in the pseudo standard cross-section image, as the pseudo ground truth data.

3. The image processing apparatus according to claim 1, further comprising:
a determining unit that determines, with respect to the pseudo teacher data, whether or not the pseudo ground truth data is data in which information of the object in the pseudo standard cross-section image is appropriately estimated, and
the pseudo teacher data included in the pseudo teacher data is the pseudo teacher data regarding which the determining unit determines that information of the object is appropriately estimated.

4. The image processing apparatus according to claim 3, wherein
information of the object is a position of a contour point of the object, and
the determining unit determines whether or not the pseudo ground truth data is data in which information of the object in the pseudo standard cross-section image is appropriately estimated, based on a pixel value of the position of the contour point of the object that the pseudo ground truth data indicates.

5. The image processing apparatus according to claim 3, wherein
information of the object is a position of a contour point of the object, and
the determining unit uses a discriminator that is trained to estimate likelihood regarding a contour of the object with the position of the contour point of the object as input to determine that the pseudo ground truth data is data in which information of the object in the pseudo standard cross-section image is appropriately estimated, in a case in which the position of the contour point of the object indicated by the pseudo ground truth data has a predetermined likelihood or higher.

6. The image processing apparatus according to claim 3, further comprising:
a display unit that displays information relating to the object indicated by the pseudo ground truth data; and
an input unit that accepts input from a user, regarding the information relating to the object displayed on the display unit, wherein
the determining unit determines whether or not the pseudo ground truth data is data in which information of the object in the pseudo standard cross-section image is appropriately estimated, based on the input from the user that the input unit accepts.

7. The image processing apparatus according to claim 1, wherein the pseudo standard cross-section image acquisition unit acquires a image that intersects the imaging plane of the three-dimensional imaging probe in the standard cross-section image, as the pseudo standard cross-section image.

8. The image processing apparatus according to claim 1, wherein the pseudo standard cross-section image acquisition unit acquires an image of a plane of which a position differs from a position of the standard cross-section or of which an orientation differs from an orientation of the standard cross-section, as the pseudo standard cross-section image.

9. The image processing apparatus according to claim 1, wherein the pseudo standard cross-section image acquisition unit acquires an image of a cross-section of which a normal direction differs from a normal direction of the standard cross-section, as the pseudo standard cross-section image.

10. The image processing apparatus according to claim 1, wherein the first learning unit learns the first learning model using deep learning, so as to take the standard cross-section image as input and output information of the object.

11. The image processing apparatus according to claim 1, wherein the second learning unit learns the second learning model using deep learning, so as to take the standard cross-section image as input and output information of the object.

12. The image processing apparatus according to claim 1, wherein the second learning unit learns the second learning model using second pseudo teacher data that is acquired by a different method from a method of acquiring the pseudo teacher data, and of which effects on training of the second learning model by the second learning unit are smaller than the pseudo teacher data, and the pseudo teacher data.

13. The image processing apparatus according to claim 1, wherein the pseudo standard cross-section image acquisition unit acquires an image including a cross-section image in a cross-section, other than a cross-section in which orientation of the standard cross-section is rotated about an irradiation direction of an ultrasound beam irradiated from the three-dimensional imaging probe as an axis, as the pseudo standard cross-section image.

14. The image processing apparatus according to claim 1, further comprising:
a three-dimensional image acquisition unit that acquires the three-dimensional image in which the object is imaged using the three-dimensional imaging probe.

15. The image processing apparatus according to claim 1, wherein
the teacher data acquisition unit acquires a teacher dataset that is made up of a plurality of pieces of the teacher data, and
the first learning unit acquires the first learning model by performing training of the teacher dataset.

16. The image processing apparatus according to claim 1, further comprising:
a pseudo teacher data acquisition unit that acquires a pseudo teacher dataset that is made up of a plurality of pieces of the pseudo teacher data, and
the second learning unit acquires the second learning model by performing training of the pseudo teacher dataset.

17. An estimating apparatus that estimates information of an object from a cross-section image in a three-dimensional image by using a learning device, wherein
the learning device includes a trained model acquisition unit that constructs a first trained model by performing training of a first learning model that estimates information of the object from the cross-section image in the three-dimensional image, using teacher data including a standard cross-section image acquired from the three-dimensional image including the object and ground truth data that is information of the object, acquires, from the three-dimensional image, a pseudo standard cross-section image corresponding to a pseudo standard cross-section that intersects an imaging plane of a three-dimensional imaging probe and that is different from a standard cross-section, acquires information of the object that is estimated using the pseudo standard cross-section image and the first trained model, as pseudo ground truth data, and constructs a second trained model by performing training of a second learning model using pseudo teacher data including the pseudo standard cross-section image and the pseudo ground truth data,
the estimating apparatus comprising:
an input image acquisition unit that acquires a standard cross-section in the three-dimensional image, in which the object is imaged using the three-dimensional imaging probe, as an input image; and
an estimating unit that performs estimation of information of the object by the input image and the second trained model.

18. An image processing apparatus, comprising:
an image acquisition unit that acquires a standard cross-section image, which is an image of a standard cross-section, from a three-dimensional image including an object;
a teacher data acquisition unit that acquires, with respect to the standard cross-section image, teacher data including the standard cross-section image and ground truth data that is information of the object in the standard cross-section image;
a pseudo standard cross-section image acquisition unit that acquires, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image;
a pseudo teacher data acquisition unit that acquires pseudo teacher data including the pseudo standard cross-section image and the ground truth data corresponding to the standard cross-section image that is used by the pseudo standard cross-section image acquisition unit to acquire the pseudo standard cross-section image; and
a learning unit that constructs a learning model that estimates information of the object from a cross-section image in the three-dimensional image, by performing training of the pseudo teacher data.

19. An image processing method, comprising:
an image acquisition step of acquiring a standard cross-section image, which is an image of a standard cross-section, from a three-dimensional image including an object;
a teacher data acquisition step of acquiring teacher data including the standard cross-section image and ground truth data that is information regarding the object in the standard cross-section image;
a first learning step of constructing a first learning model by performing training of the teacher data;
a pseudo standard cross-section image acquisition step of acquiring, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image;
a pseudo ground truth data acquisition step of acquiring pseudo ground truth data that is information of the object in the pseudo standard cross-section image, using the first learning model; and
a second learning step of constructing a second learning model by performing training of pseudo teacher data including the pseudo standard cross-section image and the pseudo ground truth data.

20. An estimating method of estimating information of an object from a cross-section image in a three-dimensional image by using a learning device, wherein
the learning device includes a trained model acquisition unit that constructs a first trained model by performing training of a first learning model that estimates information of the object from the cross-section image in the three-dimensional image, using teacher data including a standard cross-section image acquired from the three-dimensional image including the object and ground truth data that is information of the object, acquires, from the three-dimensional image, a pseudo standard cross-section image corresponding to a pseudo standard cross-section that intersects an imaging plane of a three-dimensional imaging probe and that is different from a standard cross-section, acquires information of the object that is estimated using the pseudo standard cross-section image and the first trained model, as pseudo ground truth data, and constructs a second trained model by performing training of a second learning model using pseudo teacher data including the pseudo standard cross-section image and the pseudo ground truth data,
the estimating method comprising:
an input image acquisition step of acquiring a standard cross-section in the three-dimensional image, in which the object is imaged using the three-dimensional imaging probe, as an input image; and
an estimating step of performing estimation of information of the object by the input image and the second trained model.

21. An image processing method, comprising:
an image acquisition step of acquiring a standard cross-section image, which is an image of a standard cross-section, from a three-dimensional image including an object;
a teacher data acquisition step of acquiring, with respect to the standard cross-section image, teacher data including the standard cross-section image and ground truth data that is information of the object in the standard cross-section image;
a pseudo standard cross-section image acquisition step of acquiring, from the three-dimensional image, a cross-section that differs from the standard cross-section as a pseudo standard cross-section image, based on a relation between an imaging plane of a three-dimensional imaging probe that performs imaging of the object in the three-dimensional image and the standard cross-section of the standard cross-section image;
a pseudo teacher data acquisition step of acquiring pseudo teacher data including the pseudo standard cross-section image and the ground truth data corresponding to the standard cross-section image that is used by the pseudo standard cross-section image acquisition unit to acquire the pseudo standard cross-section image; and
a learning step of constructing a learning model that estimates information of the object from a cross-section image in the three-dimensional image, by performing training of the pseudo teacher data.

22. A non-transitory computer readable medium that stores a program, wherein the program causes a computer to execute the image processing method according to claim 19.

23. A non-transitory computer readable medium that stores a program, wherein the program causes a computer to execute the estimating method according to claim 20.

24. A non-transitory computer readable medium that stores a program, wherein the program causes a computer to execute the image processing method according to claim 21.
